(19) United States
(12) Patent Application Publication
(10) Pub. No.: US 2026/0111711 A1
(43) Pub. Date: Apr. 23, 2026

(54) DEEP REINFORCEMENT LEARNING SYSTEM USING ASYMMETRIC SELF-PLAY FOR ROBUST MULTI-ROBOT FLOCKING

(71) Applicant: Lingnan University, Hong Kong (HK)

(72) Inventors: Sam Tak Wu KWONG, Hong Kong (HK); Yunjie JIA, Hong Kong (HK)

(21) Appl. No.: 18/919,653

(22) Filed: Oct. 18, 2024

(51) Int. Cl. G06N 3/0464; G05B 13/02; G06N 3/092; G06N 3/094

(52) U.S. Cl. CPC G06N 3/0464; G05B 13/027; G06N 3/092; G06N 3/094

(57) ABSTRACT

A tasked robot for a deep reinforcement learning system using asymmetric self-play for robust multi-robot flocking is provided. The tasked robot includes a reinforcement learning control module and an auxiliary training module. The control module dynamically adjusts the robot's behavior to optimize decisions, featuring a target navigation model, a cluster behavior maintenance model, and a collision avoidance model. The auxiliary training module enhances environmental perception, enabling the robot to predict dynamic changes. The auxiliary training module includes a local environment grid estimation model to generate small-scale maps and a motion prediction model to forecast robot and obstacle trajectories.

### TECHNICAL FIELD

The present invention relates to technologies for robust multi-robot flocking approach; and in particularly to deep reinforcement learning systems using asymmetric self-play for robust multi-robot flocking.

### BACKGROUND

Flocking control is a crucial technique for the safe and survivable navigation of robot groups, enabling robots to reach a target area in close proximity to each other without collisions. However, most existing flocking solutions assume static or constant behavior of obstacles, which limits their ability to address malicious physical attacks. Safe cooperative navigation requires the development of flocking policies that can handle adversarial environments with dynamic interference. A vast body of literature aims to achieve flocking by adhering to the three principles: (1) collision avoidance, (2) velocity matching, and (3) flock centering.

Traditional approaches, such as artificial potential field (APF)-based and model predictive control (MPC)-based methods, have been proposed to address these principles. However, manually designed rules, while intuitive, often fall into local minimum traps and suffer significant performance degradation when scenarios change. Additionally, these methods generally assume full access to environmental information and involve tedious scenario-specific designs, which limits their feasibility and robustness in complex and dynamic environments.

In recent years, deep reinforcement learning (DRL) has demonstrated remarkable performance in numerous multi-robot system tasks, offering an alternative solution for flocking control in complex scenarios. Several DRL-based frameworks have shown the ability to avoid collisions in static obstacle environments. Furthermore, some approaches have been proposed to cope with dynamic obstacles. However, the behavior of obstacles in these works remains static, which limits the impact on policy performance. Consequently, flocking models trained under such conditions may overfit to the fixed obstacle behaviors, reducing their generalizability to unseen settings.

Therefore, there is a need to develop robust flocking approaches that can effectively handle realistic and dynamic scenarios for enhancing the performance and reliability of multi-robot systems operating in complex environments.

### SUMMARY OF INVENTION

As described above, flocking control is a critical approach for ensuring the survivable navigation of multi-robot systems, with wide applications in fields such as logistics, service delivery, and search and rescue. However, real-world environments are often complex, dynamic, and even hostile, posing significant risks to the safety of flocking robots.

To address this challenge, an Asymmetric Self-play-empowered Flocking Control (ASFC) framework, based on deep reinforcement learning, is provided. In the present invention, flocking robots are trained alongside adversarial interferers, whose behaviour is also learnable, to stimulate the development of a more intelligent flocking strategy. A two-stage self-play training paradigm enhances the robustness and generalization of the model. Additionally, an auxiliary training module focusing on transition dynamics is incorporated, significantly improving adaptability to environmental uncertainties. The framework leverages feature-level and agent-level attention mechanisms for action and value generation, respectively. Extensive comparative experiments and real-world deployment demonstrate the superiority and practicality of the proposed framework.

In accordance with a first aspect of the present invention, a tasked robot for a deep reinforcement learning system using asymmetric self-play for robust multi-robot flocking is provided. The tasked robot includes a reinforcement learning control module and an auxiliary training module. The reinforcement learning control module is configured to dynamically adjust robot's behavior to help it make optimal decision and to continuously learn and improve through real-time feedback mechanisms. The reinforcement learning control module comprises: a target navigation model, a cluster behavior maintenance model, and a collision avoidance model. The target navigation model is for guiding the tasked robot toward a predetermined target area, continuously calculating a distance from the tasked robot to the target area, and generating action commands based on calculated information, guiding the tasked robot to reduce the distance to the target area. The cluster behavior maintenance model is for maintaining cluster behavior and monitoring relative positions and distances between or among other robots with respect to the tasked robot, such that the cluster behavior maintenance model adjusts movement of the tasked robot to maintain coordination within a robot group. The collision avoidance model is for collision avoidance, in which the collision avoidance model adjusts a trajectory for the tasked robot in response to a relative position of obstacles and interferer robots. The auxiliary training module is configured to enhance environmental perception for the tasked robot, enabling the tasked robot to predict dynamic changes around the tasked robot. The auxiliary training module comprises: a local environment grid estimation and a motion prediction model. The local environment grid estimation model is configured to generate a small-scale environmental grid map at each time step, so as to display a status of obstacles, interferences, and other robots around the tasked robot, which provides contextual information for making subsequent decisions for the tasked robot. The motion prediction model is configured to analyze and predict trajectories of other robots and properties of obstacles and interferences, based on the generated environmental grid map.

In accordance with a second aspect of the present invention, a deep reinforcement learning system using asymmetric self-play for robust multi-robot flocking is provided. The deep reinforcement learning system includes a plurality of interferer robots, a plurality of static obstacles, a start area and a target area, and a plurality of tasked robots. The tasked robots are activated to move from the start area to the target area, navigating past the interferer robots and the static obstacles. Each of the tasked robots is equipped with physical communication devices, enabling real-time data transmission and information sharing for coordination and cooperation with other tasked robots. Each of the tasked robots comprises: a reinforcement learning control module and an auxiliary training module. The reinforcement learning control module is configured to dynamically adjust robot's behavior to help it make optimal decision and to continuously learn and improve through real-time feedback mechanisms. The reinforcement learning control module comprises: a target navigation model, a cluster behavior maintenance model, and a collision avoidance model. The target navigation model is for guiding the tasked robot toward the target area, continuously calculating a distance from the tasked robot to the target area, and generating action commands based on calculated information, guiding the tasked robot to reduce the distance to the target area. The cluster behavior maintenance model is for maintaining cluster behavior and monitoring relative positions and distances between or among other robots with respect to the tasked robot, such that the cluster behavior maintenance model adjusts movement of the tasked robot to maintain coordination within a robot group. The collision avoidance model is for collision avoidance, in which the collision avoidance model adjusts a trajectory for the tasked robot in response to a relative position of the interferer robots and the static obstacles. The auxiliary training module is configured to enhance environmental perception for the tasked robot, enabling the tasked robot to predict dynamic changes around the tasked robot. The auxiliary training module comprises: a local environment grid estimation model configured and a motion prediction model. The local environment grid estimation model is configured to generate a small-scale environmental grid map at each time step, so as to display a status of the interferer robots, the static obstacles, and other robots around the tasked robot, which provides contextual information for making subsequent decisions for the tasked robot. The motion prediction model is configured to analyze and predict trajectories of other robots and properties of the interferer robots and the static obstacles, based on the generated environmental grid map.

By the configuration above, the proposed solution is an Asymmetric Self-play-empowered and DRL-based Flocking Control framework (ASFC), so as to enhance policy robustness in dynamic scenarios. In this framework, dynamic obstacles are treated as adversarial interferers with learnable policies that evolve simultaneously with the flocking policy. This asymmetric adversarial training process serves as a natural curriculum, allowing the flocking policy to be progressively refined by facing increasingly sophisticated interferers. Furthermore, communication-denied environments are assumed to enhance the practical applicability of the framework.

The contributions of the present invention are summarized as follows:

(I): A novel flocking framework based on two-stage asymmetric self-play is proposed, significantly improving the robustness and generalization of the policy, which is crucial for applying flocking control to complex scenarios.

(II): An innovative self-supervised auxiliary training module is integrated into the DRL-based architecture to enhance adaptability to environmental uncertainties.

(III): Feature-level and agent-level attention mechanisms are introduced for action and value generation, respectively, endowing the approach with scalability for arbitrarily sized swarms.

(VI): Extensive ablation studies and comparative experiments with state-of-the-art methods demonstrate the superiority of our framework. Additionally, physical experiments on a robot platform further validate its practicality.

### BRIEF DESCRIPTION OF DRAWINGS

Embodiments of the invention are described in more details hereinafter with reference to the drawings, in which:

FIG. 1 depicts the local observation of robot;

FIG. 2 depicts the network architecture of the proposed ASFC according to some embodiments of the present invention;

FIG. 3 shows Algorithm 1 for the proposed two-stage flocking training with the proposed auxiliary loss of the present invention;

FIG. 4 shows Table I with the parameters of the training;

FIG. 5 is the reward performance of models in the same test scenario, in which each model is saved and evaluated every 2000 episodes during training;

FIG. 6 shows Table II for recording the corresponding metrics;

FIG. 7 depicts trajectories of ASFC method with three scenarios, in which RAND scene including (a-1), (a-2), (a-3), DWA scene including (b-1), (b-2), (b-3), and HEUR scene including (c-1), (c-2), (c-3);

FIG. 8 shows snapshots of four flocking robots adopting ASFC and two heuristic adversarial interferers, including part (a), (b), (c), and (d);

FIG. 9 depicts a schematic drawing architecture of a deep reinforcement learning system using asymmetric self-play for robust multi-robot flocking according to one embodiment of the present invention; and

FIG. 10 depicts a schematic drawing of an architecture of a tasked robot according to one embodiment of the present invention.

### DETAILED DESCRIPTION OF THE INVENTION

In the following description, deep reinforcement learning systems using asymmetric self-play for robust multi-robot flocking and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

To facilitate the understanding of the technical content of the present invention, the following description provides an introduction to the related work for this field, giving the introduction on deep reinforcement learning-based (DRL-based) flocking control and asymmetric self-play technique.

### Related Work-(A): DRL-based Flocking Control

DRL has emerged as a promising solution for flocking control in a variety of situations. A Q-learning-based approach has been presented, where a group of fixed-wing unmanned aerial vehicles (UAVs) learn to flock in a leader-follower topology. In other works, single-agent DRL and local situation maps concerning collision risk are applied to generate collision-free strategies. For adaptation to scenarios with static obstacles, a curriculum-based framework has been proposed. Additionally, the demonstration of a non-expert prior policy has been utilized to enhance sample efficiency. In some works, an approach based on a sequential attention mechanism and behavioral reasoning is introduced to handle stochastic communication environments. Moreover, a DRL-based flocking algorithm has been designed to eliminate communication dependency. To address dynamic obstacles, a graph attention-based network has been developed, though the movement patterns of the dynamic obstacles remain fairly simple, limiting model generalizability. In contrast, under the assumption of non-communicability, the behavior of dynamic obstacles is allowed to be complex and aggressive in the present invention, and an effective flocking framework robust to environmental interference is proposed.

### Related Work-(B): Asymmetric Self-Play

The self-play mechanism has become a training approach adopted by many well-known systems, such as AlphaGo and Google Football. It stimulates the intelligence of an agent by training it with a learnable adversarial opponent. Asymmetric self-play implies that the opponent and the agent have different abilities and objectives. In some works, a visual tracker is trained with a learnable target that attempts to escape, thereby improving the tracking strategy. Furthermore, in some works, a cooperative team consisting of a target and multiple distractors is utilized to play against the tracker, enhancing its robustness. In multi-agent settings, a learnable runner has been trained together with a heterogenous catching system to improve the catching skills.

Based on those related works, the present disclosure proposes a novel two-stage self-play training paradigm: the first stage focuses on enhancing model performance, while the second stage aims to promote model generalization.

Next, the problem formulation and system model are provided. A detailed statement of the identified problem and its setting is first presented, followed by a formal description of the observations and actions.

### Problem Formulation and System Model-(A): Problem Statement

In the present disclosure, the purpose is for a swarm of differential wheeled robots tasked with navigating from a start area to a target area while maintaining a flocking motion pattern. The scenario includes not only static obstacles but also adversarial and learnable interferers, represented by another group of robots. The robots are not permitted to communicate with each other and must make distributed decisions based solely on their local observations.

For each robot, the sub-objectives of flocking control are as follows: (1) minimizing navigation time; (2) minimizing the distance from the flocking center and reducing heading deviation relative to other robots; and (3) avoiding collisions with neighbors, static obstacles, and interferers. In contrast, during adversarial training, the interferers aim to collide with the robots, thereby disrupting their flocking behavior. It is important to note that both the robot team and the interferers are scalable, meaning the control policy must be population-invariant. In the context of reinforcement learning (RL), this problem is formulated as a decentralized partially observable Markov decision process (Dec-POMDP).

### Problem Formulation and System Model-(B): Observation Space

Two issues are discussed herein, including: (1) Robot's Observation and (2) Interferer's Observation.

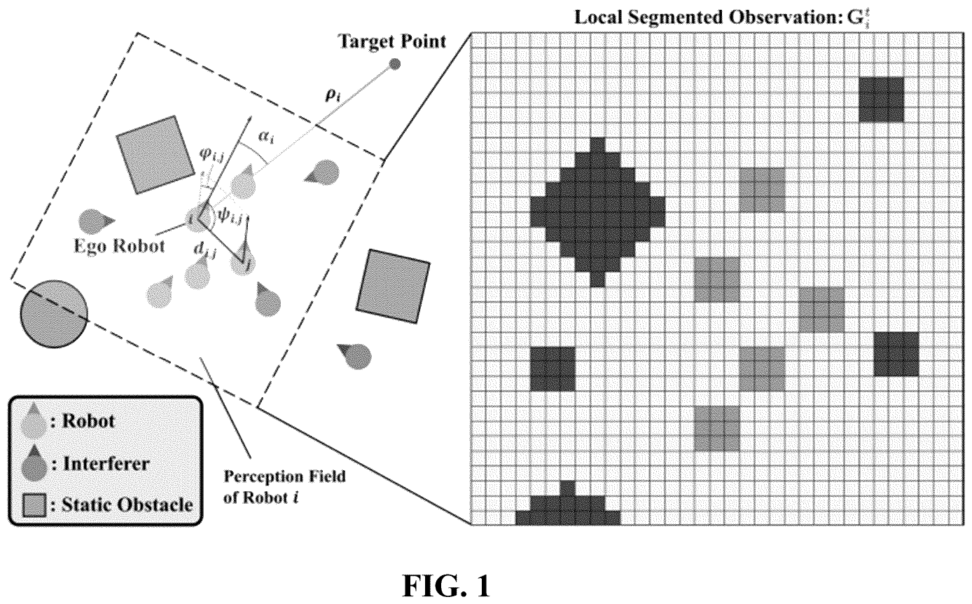

(1) Robot's Observation: FIG. 1 depicts the local observation of robot i. In addition to vector-format inputs, a local grid map is employed to represent the self-centered surrounding environment. In the perspective of robot i, the observation is denoted as oᵢ:=(sᵢ, pᵢ, [symbol] ᵢ, ξ_{Ni}, ξ_{Mi}), where sᵢ:=(vᵢ, ωᵢ) is its linear and angular velocity, and pᵢ:=(ρᵢ, αᵢ) denotes the relative position (i.e. distance ρᵢ and angle αᵢ) of the target, as depicted in FIG. 1. Note that pᵢ is the only non-local component of the observation that is available through a global position system. Based on widely used grid-like sensors,

$${𝒢}_{i} := ( {G}_{i}^{t} , {G}_{i}^{t - 1} , {G}_{i}^{t - 2} )$$

denotes a 3-channel local grid map representing the self-centered surrounding environment of the nearest 3 time steps, where

$${G}_{i}^{t} ∈ {ℝ}^{{N}_{g} \times {N}_{g}}$$

is the newest grid map and N_{g} is the input length. The resolution is 0.12 m. In each channel of [symbol] ᵢ, each entity category, i.e., free space, static obstacle, robot, and interferer, is denoted by 0, 1, 2, and 3, respectively (shown in different colors in FIG. 1). Σ_{N}_{ᵢ}:={τ_{i,j}|jϵNᵢ and τ_{M}_{ᵢ}:={Σ_{i,j}|jϵMᵢ refer to the observable states of the set of other flocking robots (Nᵢ) and interferers (Mᵢ) within the field of view

$${G}_{i}^{t} ,$$

respectively. Specifically, for a movable entity j (robot or interferer) within the field of view, ξ_{i,j} is defined as ξ_{i,j}:=(d_{i,j}, ψ_{i,j}, φ_{i,j}), where d_{i,j}, ψ_{i,j}, and φ_{i,j} represent the relative distance, the relative angle, and the orientation difference between entity j and robot i, respectively.

Remarkably, the observation is distributed, local, and self-centered, and all quantities are relative except velocities, for the purpose of the generalization to different maps. It is also worth mentioning that the number of elements in sets Nᵢ and Mᵢ is changeable or even zero, suggesting that our network should be able to handle a variable number of neighbors and interferers.

2) Interferer's Observation: For an interferer k, its observation is represented as

$${o}_{k} : = ( {s}_{k} , {𝒢}_{k} , {ξ}_{{M}_{k}^{+}} , {ξ}_{{N}_{k}^{+}} ) ,$$

where the meaning of the first two elements is referenced accordingly to the observation of robot. The robot set

$${N}_{k}^{+}$$

and interferer set

$${M}_{k}^{+}$$

of interferer k contains all robots and interferers in the global scope rather than the local scope, implying that the observable range of an interferer is larger than that of a robot.

### Problem Formulation and System Model-(C): Action Space

In the proposed system, both the robots and interferers execute steering commands consisting of linear and angular velocities. The action space is designed as a set of velocity option combinations. Specifically, for each robot, the action space includes four linear velocity options: {0, 0.15, 0.3, 0.5} m/s, and nine angular velocity options: {−2, −1.2, −0.8, −0.3, 0, 0.3, 0.8, 1.2, 2} rad/s. For an interferer, the angular velocity options remain the same as those of the robots, while the linear velocity options are {0, 0.15, 0.3, 0.38} m/s. The difference in maximum speed between robots and interferers is introduced as a compensation for the varying difficulty of their respective tasks. As a result, the action space for both a robot and an interferer consists of 36 distinct velocity combinations.

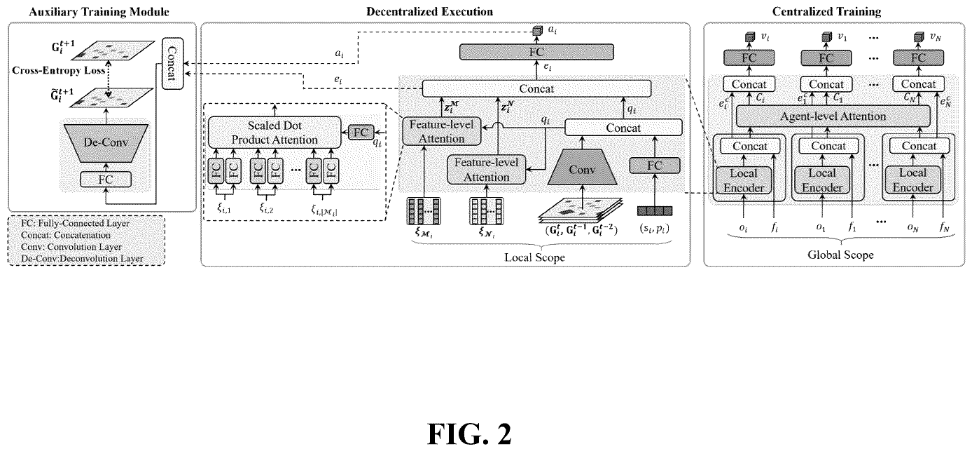

The methodology is discussed. FIG. 2 depicts the network architecture of the proposed ASFC according to some embodiments of the present invention. Feature-level and agent-level attention mechanisms are developed for action and value generation, respectively, enabling the scalability of ASFC. An auxiliary training module is designed to predict the next local map (the left part). Note that the left and right parts are only required during training to ease policy learning, while they are inactive during execution.

The details of ASFC are provided in this part, including the design of the proposed network architecture (as shown in FIG. 2), the auxiliary training module, the reward function, and the two-stage training paradigm. There are four key points to be discussed, including: (A) Action and Value Learning; (B): Auxiliary Training

Module; (C): Reward Function; and (D): Two-Stage Self-Play Training.

### (A) Action and Value Learning

Two considerations are taken into account in our network design. One is that it should be able to process variable numbers of robots and interferers, and the other is that it is expected to satisfy the Centralized Training and Decentralized Execution (CTDE) paradigm, since the integration of extra information into the critic network has been shown to be effective to ease training. For the first concern, the attention mechanism is adopted as its population and permutation invariance. Regarding the second concern, a self-centered global agent-level communication module is designed to augment the information of the critic network.

1) Action Learning: The action learning of the architecture is depicted in the middle part of FIG. 2. For robot i, the local segmented map [symbol] ᵢ and (sᵢ, pᵢ) are embedded by a convolution neural network (CNN) and a multi-layer perceptron (MLP), respectively, and then the outputs are concatenated as the self-feature qᵢ. Next, based on the query-key-value mechanism, the self-feature qi of robot i serves as a query to aggregate information from the set of robot features ξ_{N}_{ᵢ} and the set of interferer features ξ_{M}_{ᵢ} within its perception field. The robot feature embedding

$${z}_{i}^{N}$$

and interferer feature embedding

$${z}_{i}^{M}$$

based on the self-feature qᵢ of robot i is computed as:

$${z}_{i}^{N} = {\sum }_{j ∈ {N}_{i}} {u}_{ij}^{N} {W}_{v}^{N} FC ( {ξ}_{i , j} ) : {z}_{i}^{M} = {\sum }_{j ∈ {M}_{i}} {u}_{ij}^{M} {W}_{v}^{M} FC ( {ξ}_{i , j} ) \qquad ( 1 )$$

where

$${W}_{v}^{N} and {W}_{v}^{M}$$

are trainable parameters, and the coefficients

$${u}_{ij}^{N} and {u}_{ij}^{M}$$

are the normalized importance scores:

$${u}_{ij}^{N} = σ ( {τ}^{N} \cdot {W}_{q}^{N} FC ( {q}_{i} ) \cdot {( {W}_{k}^{N} FC ( {ξ}_{i , j} ) )}^{T} ) ;$$

$${u}_{ij}^{M} = σ ( {τ}^{M} \cdot {W}_{q}^{M} FC ( {q}_{i} ) \cdot {( {W}_{k}^{M} FC ( {ξ}_{i , j} ) )}^{T} ) \qquad ( 2 )$$

where

$${τ}^{N} = 1 / dim ( {W}_{k}^{N} FC ( {ξ}_{i , j} ) ) and {τ}^{M} = 1 / dim ( {W}_{k}^{M} FC ( {ξ}_{i , j} ) )$$

are scaling factors;

$${W}_{q}^{N} , {W}_{k}^{N} , {W}_{q}^{M} , {W}_{k}^{M}$$

are trainable parameters; σ is the Softmax function.

Then, the robot feature embedding

$${z}_{i}^{N} ,$$

the interferer feature embedding

$${z}_{i}^{M} ,$$

and self-feature qᵢ are concatenated into eᵢ as the local feature, used as the input of the actor network implemented by a two-layer MLP. The action aᵢ is sampled according to the output probability of the last layer in the actor network using the SoftMax function. In addition, the network architecture of the interferer is basically the same as above. The main difference is that the input

$${ξ}_{{M}_{k}^{+}} and {ξ}_{{N}_{k}^{+}}$$

of an interferer k is globally scoped and its feature eₖ goes through a policy branch and a critic branch, respectively, both realized by a two-layer MLP, to generate the action and value of the interferer.

2) Value Learning: To enhance value learning, all robots are allowed to exchange agent-level information with each other to generate values. Note that the policy network still conforms to the no-communication assumption during execution. Agent-level attention is implemented, enabling the robot to aggregate global features by learning the importance of others, as shown in the right part of FIG. 2. Specifically, in the view of robot i, the local total features.

$${e}_{i}^{c}$$

are obtained by concatenating its local feature erei and flocking feature fᵢ. fᵢϵ [symbol] ² is the privileged information of flocking, consisted of the relative distance and the relative angle between the flocking center point and robot i. Then, robot i receives the local features from other robots

$${N}_{i}^{+} ,$$

and calculates the relative importance of any robot

$$j ∈ {N}_{i}^{+}$$

as follows.

$${α}_{ij} = \frac{exp ( τ \cdot {W}_{Q} {e}_{i}^{c} \cdot {( {W}_{K} {e}_{j}^{c} )}^{T} )}{{\sum }_{l ∈ {N}_{i}^{+}} exp ( τ \cdot {W}_{Q} {e}_{i}^{c} \cdot {( {W}_{K} {e}_{l}^{c} )}^{T} )} \qquad ( 3 )$$

where

$$τ = 1 / dim ( {W}_{K} {e}_{l}^{c} )$$

is a scaling factor, W_{Q} is the query parameters, and W_{K} is the key parameters. The aggregated information Ci of robot i is then obtained as follows:

$${C}_{i} = {\sum }_{j ∈ {N}_{i}^{+}} {α}_{ij} {W}_{V} {e}_{i}^{c} \qquad ( 4 )$$

where W_{V} is the value parameters.

Cᵢ and

$${e}_{i}^{c}$$

are concatenated and then passed through the critic network implemented by a two-layer MLP to generate the value vᵢ. It is noteworthy that eᵢ in the policy network and critic network are obtained from networks of the same structure with different parameters. The Proximal Policy Optimization (PPO) algorithm is adopted to optimize the action and value learning neural network, and the corresponding learning rates are ηₚ and η_{c}, respectively.

### (B) Auxiliary Training Module

In some embodiments, at each time step, flocking robots and interferers simultaneously apply distributed actions to the environment, determining the transition to the new global state. This results in a highly uncertain environment for each robot, making it desirable to help robots improve their understanding of the scenario dynamics. Enlightened by opponent modeling, an auxiliary training module is designed to predict the local grid map

$${G}_{i}^{t + 1}$$

of the next time step, as depicted in the left part of FIG. 2. Such an auxiliary signal is combined with RL signals to jointly optimize the policy network.

Specifically, the local feature e; of the policy network, in addition to being used to produce the action aᵢ (as afore described), is also used to generate

$${\tilde{G}}_{i}^{t + 1} ,$$

the estimation of the next local grid map

$${G}_{i}^{t + 1} .$$

A decoder branch composing of an MLP and several deconvolution layers constructs

$${\tilde{G}}_{i}^{t + 1}$$

based on (eᵢ, aᵢ). Since a local map contains four categories, as the semantic segmentation technique, our construction loss is defined as the cross-entropy loss:

$${L}^{c e} = - \frac{1}{{N}_{g}^{2}} {\sum }_{x = 1}^{{N}_{g}} {\sum }_{y = 1}^{{N}_{g}} {\sum }_{c = 1}^{c} I ( {G}_{i}^{t + 1} ( x , y ) , c ) log ( {\tilde{G}}_{i}^{t + 1} ( x , y ) ) \qquad ( 5 )$$

where

$${G}_{i}^{t + 1} ( x , y )$$

is the ground truth class in position (x,y) of label

$${G}_{i}^{t + 1}$$

(available from the simulator), C is the category number, and I(⋅) is the binary indicator function.

The total loss during training is composed of the above loss and PPO-related losses, optimizing the network jointly in each mini-batch iteration of PPO algorithm as follows:

$${L}^{total} = {β}_{p} {L}^{pol} + {β}_{v} {L}^{val} - {β}_{e} {L}^{lent} + {β}_{a} {L}^{ce} \qquad ( 6 )$$

$${L}^{p o l} = - 𝔼 [ min ( ζ ( θ ) {\hat{A}}_{t}^{{θ}_{o l d}} , clip ( ζ ( θ ) , 1 - ϵ , 1 + ϵ ) ] {\hat{A}}_{t}^{{θ}_{o l d}} \qquad ( 7 )$$

$${L}^{val} = 𝔼 [ {( {\sum }_{t = 1}^{{t}_{max}} {γ}^{t} {r}^{t} - V ( {o}_{i} ) )}^{2} ] \qquad ( 8 )$$

$${L}^{ent} = - \sum {π}_{θ} ( {o}_{i} ) log ( {π}_{θ} ( {o}_{i} ) ) \qquad ( 9 )$$

where βₚ, βᵥ, βₑ, and βₐ are the corresponding coefficients; L^{pol} is the policy loss; L^{val} is the value loss; L^{ent} is the policy entropy; γ^{t} is the discount factor; tₘₐₓ denotes the length of an episode; V(oᵢ) is the state value function; ξ(θ) represents the policy changing ratio; e is the bounding hyperparameter or ξ(θ);

$${\hat{A}}_{t}^{{θ}_{o l d}}$$

denotes the estimator of the generalized advantage; and π_{θ}(oᵢ) represents the policy with parameter θ.

In this manner, robots are enabled to continuously learn to predict the movements of surrounding robots and interferers, thereby alleviating the effect of environmental uncertainty, as demonstrated in the ablation analysis. This module is inherently scalable, as it operates as a fixed-size local representation independent of the number of agents. Additionally, the auxiliary training module and value learning components are utilized only during the training phase to aid policy learning and are removed during execution, ensuring the system settings remain unaffected.

### (C) Reward Function

There are two key points to be discussed, including (1) Robot's Reward and (2) Interferer's Reward.

### (1) Robot's Reward:

The design of the reward function in RL is highly correlated with the task objective. On the basis of each sub-objective of the flocking control described in the descriptions as afore-mentioned, the corresponding reward function is proposed to guide RL training:

$${r}_{i}^{t} = {r}_{i , tar}^{t} + {r}_{i , flock}^{t} + {r}_{i , coll}^{t} \qquad ( 10 )$$

The first term

$${r}_{i , tar}^{t}$$

is used to encourage the robot to move towards the target area and is defined as:

$${r}_{i , tar}^{t} = \{ \begin{matrix}{λ}_{tar} , & if {d}_{i , tar}^{t} < {D}_{tar} \\ {λ}_{app} \cdot ( {d}_{i , tar}^{t - 1} - {d}_{i , tar}^{t - 1} ) , & otherwise\end{matrix} \qquad ( 11 )$$

where

$${d}_{i , tar}^{t}$$

is the distance from robot i is the distance from robot i to the center of the target area; Dₜₐᵣ determines whether the navigation is finished; λₜₐᵣ and λₐₚₚ are parameters.

The second term

$${r}_{i , flock}^{t}$$

is introduced for motivating the robot to maintain the flocking behavior:

$${r}_{i , flock}^{t} = \{ \begin{matrix}{r}_{i , ctr}^{t} + {r}_{i , ori}^{t} , & if {d}_{i , ctr}^{t} < {D}_{ctr} and {φ}_{i , ori}^{t} < {Φ}_{ctr} \\ 0 , & otherwise\end{matrix} \qquad ( 12 )$$

$${r}_{i , ctr}^{t} = {λ}_{ctr} \cdot [ {D}_{ctr} - ( 0.5 \cdot {d}_{i , ctr}^{t} ) ] \qquad ( 13 )$$

$${r}_{i , ori}^{t} = {λ}_{o r i} \cdot [ {Φ}_{o r i} - ( 0.5 \cdot {φ}_{i , o r i}^{t} ) ] \qquad ( 14 )$$

where

$${r}_{i , ctr}^{t} and {r}_{i , ori}^{t}$$

denote the reward of flocking centering and flocking orientation consistency, respectively;

$${d}_{i , ctr}^{t}$$

is the distance between robot i and the flocking center;

$${φ}_{i , ori}^{t}$$

is the average deviation of the robot orientation from that of the other robots; D_{ctr} and Φₒᵣᵢ are the thresholds of flocking centering and orientation deviation, respectively; λ_{ctr} and λₒᵣᵢ are both positive parameters. The design of

$${d}_{i , flock}^{t}$$

implies that the robot is only rewarded when it satisfies expectations in both position and orientation during flocking.

The third term

$${r}_{i , coll}^{t}$$

is designed for collision avoidance and is defined as:

$${r}_{i , flock}^{t} = \{ \begin{matrix}- {λ}_{coll} , & if collision \\ - {λ}_{int} \cdot {( \frac{1}{{d}_{i , int}^{t}} )}^{2} , & else if {d}_{i , int}^{t} < {d}_{int} \\ - {λ}_{obs} \cdot {( \frac{1}{{d}_{i , obs}^{t}} )}^{2} , & else if {d}_{i , obs}^{t} < {d}_{obs} \\ 0 , & otherwise\end{matrix} \qquad ( 15 )$$

where λ_{coll}, λᵢₙₜ, and λ_{obs} are parameters; the second and third lines are designed to instruct the robot to maintain a safe distance from interferers and obstacles, respectively;

$${d}_{i , obs}^{t} , {d}_{i , int}^{t}$$

represent the shortest distance between robot i and the obstacles and interferers, respectively, and the corresponding thresholds are Dᵢₙₜ and D_{obs}, respectively.

2) Interferer's Reward: The design of the interferer reward is relatively straightforward, with the principle of encouraging interferers to approach flocking robots and collide with them. The reward

$${r}_{k}^{t}$$

of interferer k is defined as follows:

$${r}_{i , flock}^{t} = \{ \begin{matrix}{λ}_{ad} , if collided with a robot \\ - {λ}_{avo} , else if collided with non - robot \\ {λ}_{na} \cdot {\sum }_{i ∈ {N}_{k}} {( \frac{1}{{d}_{k , i}^{t}} )}^{2}\end{matrix} \qquad ( 16 )$$

where

$${d}_{k , i}^{t}$$

denotes the distance between interferer k and robot i; λ_{ad}, λ_{ad}, and λₙₐ are parameters.

### (D) Two-Stage Self-Play Training

In self-play training of the proposed solution of the present invention, there are two aspirations. The first is that the interferers should have sufficient intelligence to stimulate robot skill learning, and the second is that the flocking policy needs to be generalizable. To this end, a novel two-stage self-play training strategy is proposed. In the first stage, for skill enhancement, the robots and interferers are trained simultaneously, while the network parameters wT of the interferers are put into the model pool W every NT episodes. In the second stage, for stronger generalization, the flocking policy obtained in the first stage begins to be trained against the whole interferer model pool W containing different levels of adversarial intelligence.

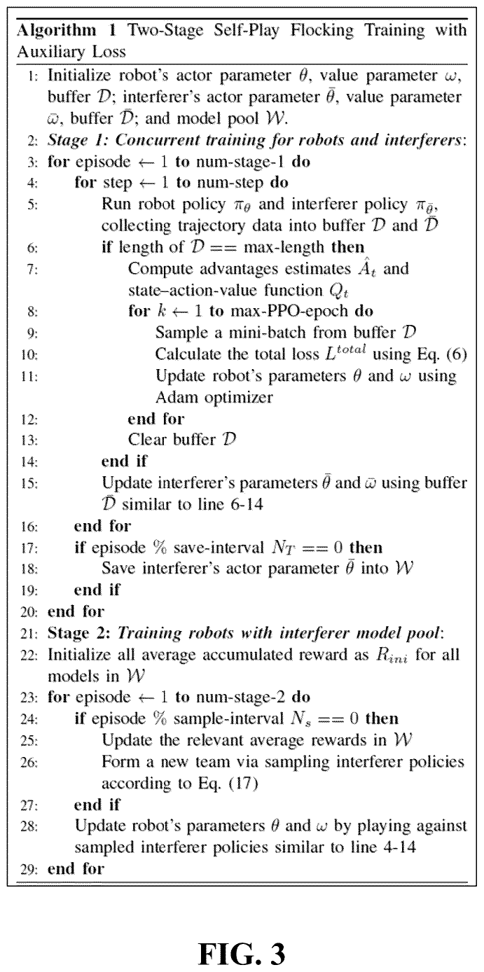

In the second training stage, two techniques are adopted to enhance environmental diversity and also incorporate curriculum learning. The first one is that the interferer model is agent-wise sampled. Assuming that there are Nₖ interferers in the team and W has N_{W} models, thus the number of all possible combinations of the interferer team is Nₖ^{N}^{_{W}}, greatly increasing the diversity of the environment. The second one is that the interferer models are sampled according to periodically updated weights, i.e., progressively focusing on stronger models. In particular, the interferer team is updated every Nₛ episodes by a new weighted sample in W. The probability of a model θ̅^{T} of being selected, pₛₐₘₚₗₑ(θ̅^{T}), depends on its performance when it was last selected, i.e., its average accumulated reward R_{θ̅}_{^{T}}:

$${p}_{s a m p l e} ( {\overline{θ}}^{T} ) = \frac{clip ( {R}_{\overline{θ}} r , {R}_{min} , {R}_{max} )}{{Σ}_{{\overline{θ}}^{x} ∈ W} clip ( {R}_{{\overline{θ}}^{x}} , {R}_{min} , {R}_{max} )} \qquad ( 17 )$$

where Rₘᵢₙ and Rₘₐₓ are the lower and upper bounds, respectively. The initial reward for each model in W of the second stage is assigned as Rₘᵢₙ. Intuitively, such an iterative weighted sampling allows for a gradual increase of scene difficulty for flocking. The proposed two-stage flocking training with the proposed auxiliary loss of the present invention is outlined in Algorithm 1 of FIG. 3.

Experiments are provided. Simulation experiments in a variety of scenarios demonstrate the superiority of the proposed framework, and physical experiments verify its practicality.

### Experiments-(A) Experimental Setup

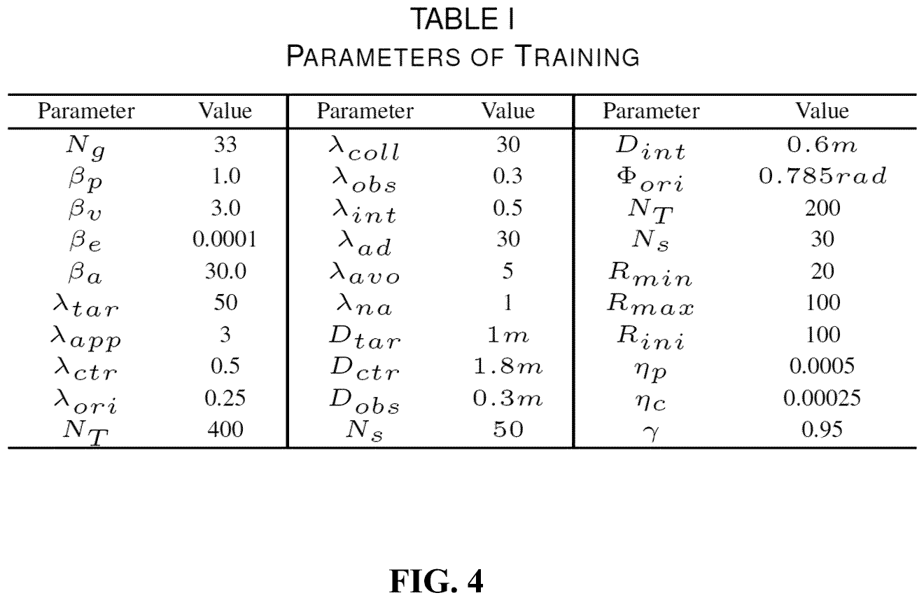

1. Configurations: The simulations are conducted with the 3D simulator PyBullet on a server with set CPU and GPU. In the two-stage flocking training, the scenario of the first stage is 15 m×15 m in size with five flocking robots, three interferers, and two static obstacles, while the scenario of the second stage is 25 m×25 m in size with eight robots, six interferers, and five static obstacles. The robot and the interferer are modeled as disc shapes, both with a radius of 0.18 m, while the obstacle set is composed of cylinders with a diameter of 1 m and cubes with a side length of 1 m. In each episode, flocking robots are initialized within 1 m of a randomly selected start point near the scenario edge, while the target point is the symmetric point of the start point with respect to the scenario center. Interferers and obstacles are randomly initialized throughout the scenario. An episode is regarded as completed when the robots move within 1 m of the target point. The parameters of the training are shown in Table I of FIG. 4.

2. Ablation Baselines: To verify the contributions of the key components of ASFC, the following three variants are adopted for comparison. First, to show the benefits of self-play training, an ablation is developed, denoted as ASFC-S, where the interferers are controlled by a heuristic adversarial strategy (denoted as HEUR strategy), while the flocking policy is configured in the same way as ASFC. This means each interferer moves greedily towards the closest flocking robot. Secondly, to demonstrate the effectiveness of two-stage training, a method without the second stage, ASFC-G, is used. It is trained concurrently with interferers through the entire process for the same total number of episodes, and the environment is configured in the same way as the second stage of ASFC. Furthermore, to exhibit the contribution of the auxiliary loss, ASFC-A is implemented without the auxiliary training module. The rest of its configurations are the same as ASFC.

### 3. Ablation Baselines: Performance Metrics:

The following metrics are utilized to evaluate the models from multiple perspectives:

1. Collision avoidance metrics: The collision rate (CR) and the private space disturbance rate (PR) are used for collision avoidance evaluation. CR represents the average rate at which a robot collides with other entities, while PR represents the average rate at which a robot's distance from the nearest interferer is less than 0.6 m.

2. Flocking behavior metrics: The flocking centering distance (FCD) and the flocking orientation deviation (FOD) are introduced to estimate the flocking performance. For each robot, FCD is its average distance to the flocking center, while FOD is its average directional deviation from the directions of other robots.

3. Target arrival metrics: The average speed (AS) and extra distance rate (EDR) are employed for target-reaching evaluation. AS is calculated by dividing the trajectory length by the navigation time. EDR denotes the percentage of redundant distance in the whole trajectory of an episode. A large EDR implies that the robot detours a long distance.

### Experiments-(B) Training Details

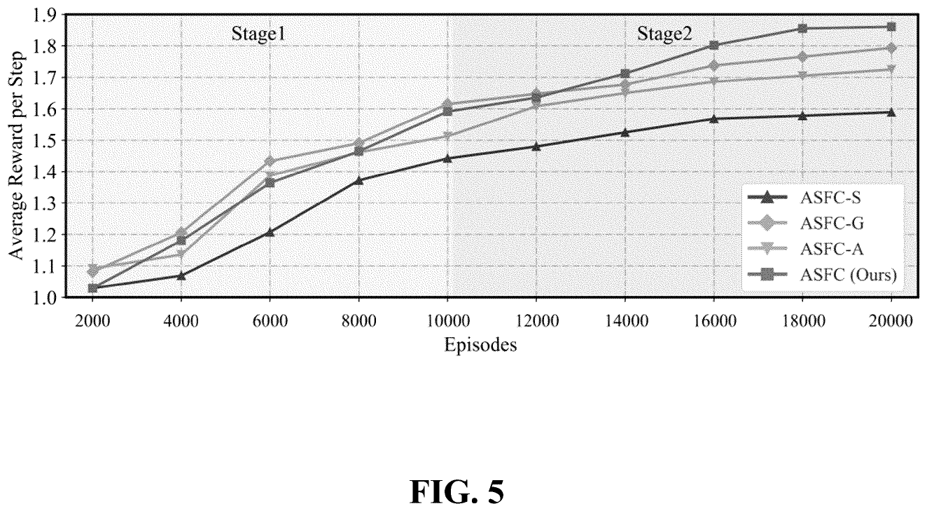

For all models, there are 10,000 episodes in each stage of the two-stage training. To present the learning process, models are evaluated every 2,000 episodes in the same test scenario. The test scenario is 25 m×25 m in size with eight robots, six interferers, and five static obstacles. Every saved model is run for 100 episodes for each evaluation. For each testing episode, each interferer's strategy is randomly sampled from three strategies: the HEUR strategy, the Dynamic Window Approach (DWA) (DWA strategy), and the random motion strategy (RAND strategy). The latter two strategies are non-adversarial. The DWA strategy only considers the presence of other entities except robots, implying that the responsibility for collision avoidance is given to the flocking robots. FIG. 5 is the reward performance of models in the same test scenario, in which each model is saved and evaluated every 2000 episodes during training. The average rewards of flocking are depicted in FIG. 5.

First of all, it is observed that ASFC yields the highest rewards, proving its superiority. Second, in contrast to ASFC-S, ASFC has higher rewards thanks to the self-playing training mechanism. The reward of ASFC-S barely rises after 12,000 episodes, suggesting that the interference of fixed behavior offers limited benefits to the flocking performance. Furthermore, the outperformance of ASFC over ASFC-G further proves that the proposed two-stage training mechanism enhances the generalization ability to complex scenarios. Additionally, the effectiveness of the auxiliary training module is illustrated in the comparisons of ASFC versus ASFC-A.

### Experiments-(C) Comparative Experiments in Various Scenarios

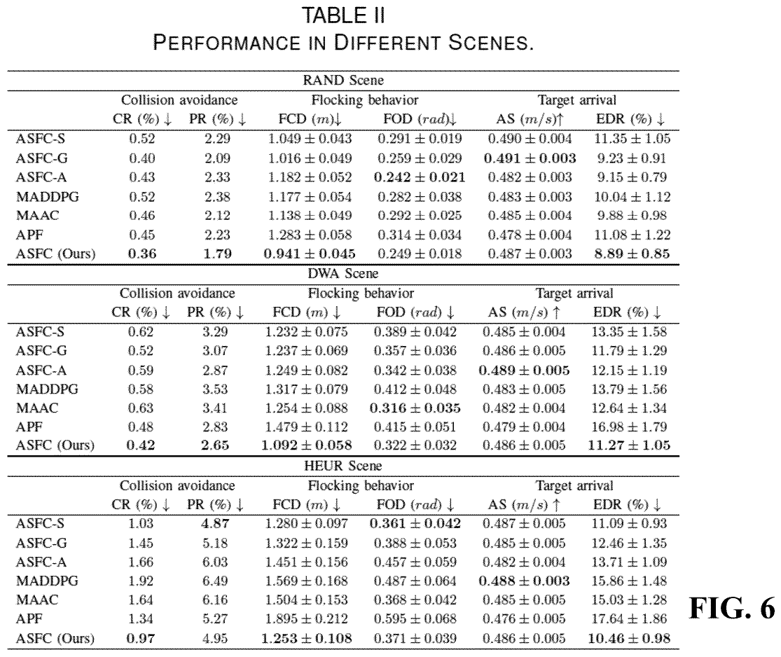

In this subsection, the performance of each model under different interferer strategies is evaluated. The three scenarios are named as RAND Scene, DWA Scene, and HEUR Scene, respectively, where the corresponding interferer strategies are the RAND strategy, DWA strategy, and HEUR strategy. Each scenario has a size of 25 m×25 m with 10 flocking robots, 8 interferers, and 5 static obstacles. For each evaluation, 100 tests are performed. Moreover, to demonstrate the superiority of our method, three state-of-the-art methods are used for comparison: 1) MADDPG; 2) MAAC; and 3) APF. The first two learning-based methods are trained using the same self-play mechanism for fairness. APF is a traditional approach where the target point and flocking center have attractive potential fields, while robots, static obstacles, and interferers have repulsive potential fields. The corresponding metrics as afore-described are recorded, as shown in Table II of FIG. 6 (the best performance is highlighted in bold).

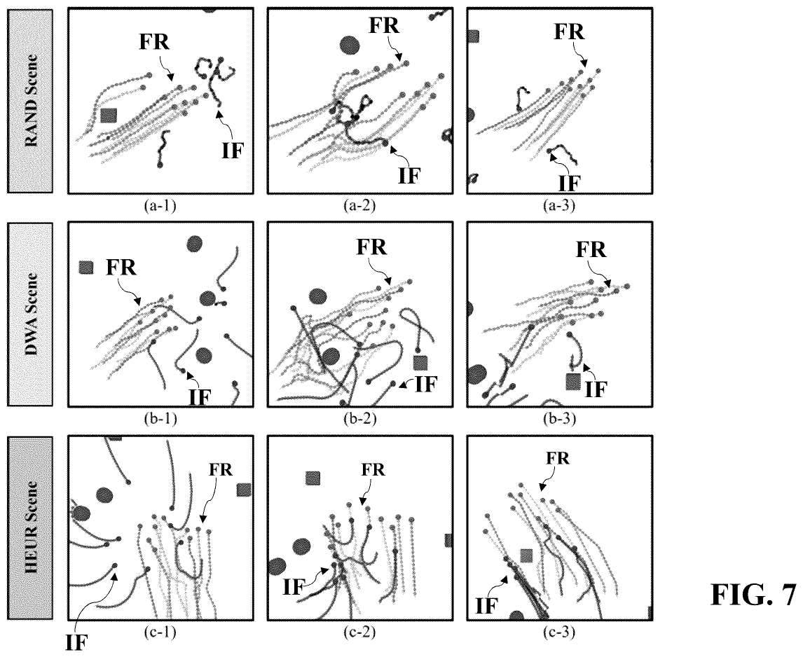

It is shown that ASFC has the lowest CR and the smallest FCD in all scenarios, illustrating its advantages. Besides, ASFC also yields the lowest EDR, which we attribute to the fact that the robots are able to make both safe and not overly conservative decisions. Meanwhile, it is exhibited that the auxiliary loss for modeling environmental dynamics assists in the robustness of flocking. In addition, ASFC also achieves better results with only local observations compared with APF, which uses global information. Furthermore, the sampled behavior of ASFC is provided for each testing scenario, as shown in FIG. 7. FIG. 7 depicts trajectories of ASFC method with three scenarios, in which RAND scene including (a-1), (a-2), (a-3), DWA scene including (b-1), (b-2), (b-3), and HEUR scene including (c-1), (c-2), (c-3). In each scenario, trajectories for three time frames are presented. The flocking robots FR are represented with trajectories, and interferers IF are represented with trajectories as well. It is demonstrated that the robots are able to avoid the impact of diverse interferers while efficiently maintaining the desired flocking behavior. It is also noticed that once away from the interference, the robots gradually form a denser and more consistent flock.

### Experiments-(D) Real Experiment Demonstration

In addition to the simulations, the proposed ASFC is deployed in physical robots to demonstrate the practicability of our approach. Specifically, a scenario with a size of 4 m×4 m is built, containing four robots, two interferers, and two static obstacles. AgileX LIMO mobile robots with four-wheel differential steering mode are utilized as robots and interferers. The ASFC trained in the simulation is used as the flocking policy for the real experiment, while the interferers follow the HEUR strategy. A wireless communication system is constructed by a router and connects the robots as mobile nodes to a control station. The control station is equipped with a CPU and a GPU, serving as the data transceiver for all robots. The control station receives inference-related data from the robots, calculates actions, and then transmits them to the relevant robots. This setup does not violate our distributed execution design, as the onboard processors of the robots may be modified for deep learning inference.

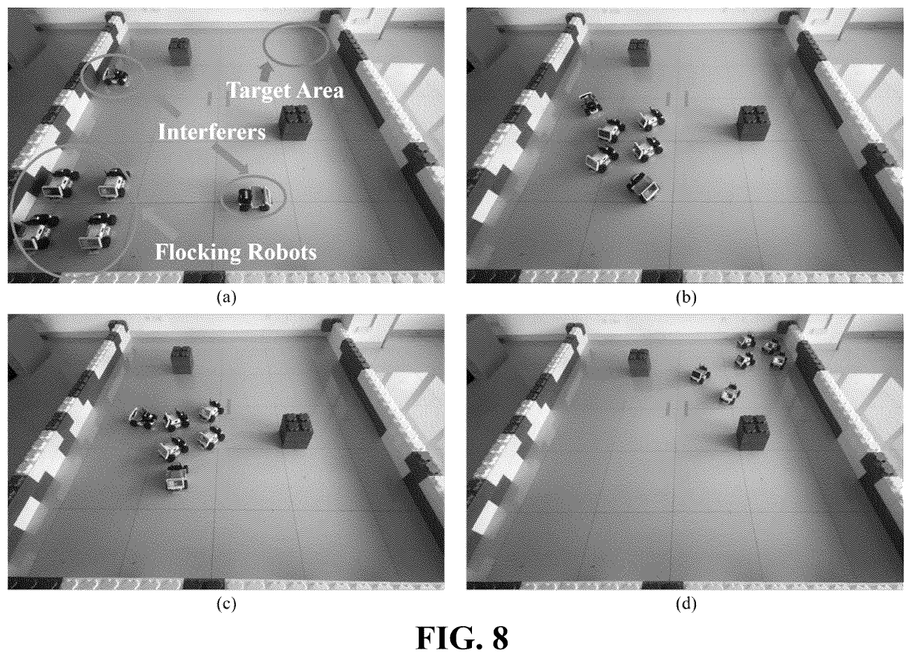

The model is run on this robot platform, and the process is recorded using a camera. FIG. 8 shows snapshots of four flocking robots adopting ASFC and two heuristic adversarial interferers, including part (a), (b), (c), and (d). The snapshots of an episode are provided in FIG. 8, showing that the robots are able to evade interference while maintaining a flock until reaching the target area. Additionally, the computation time for each run of our model is 2.25 ms, which is much smaller than the system's decision interval of 200 ms. These experiments demonstrate that the proposed framework satisfies both sim-to-real deployment and real-time demands, indicating its potential for practical applications.

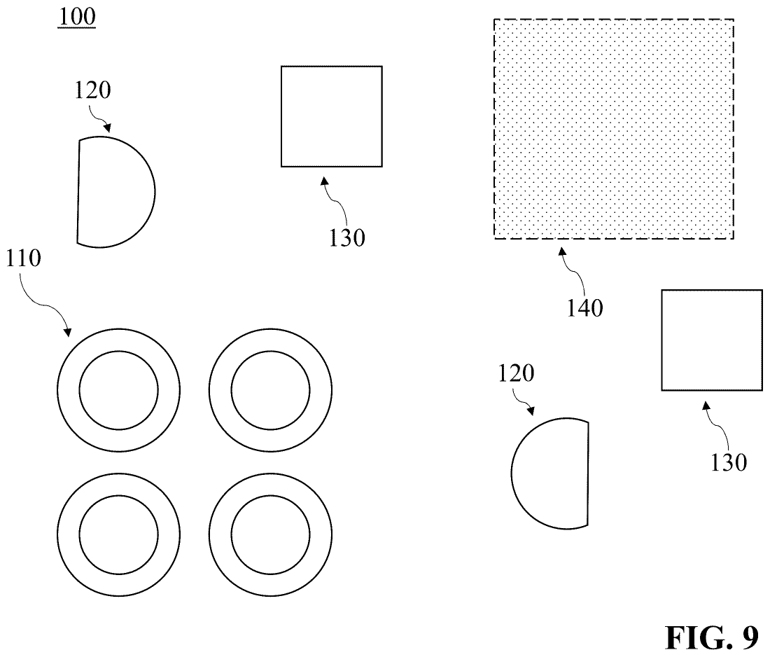

FIG. 9 depicts a schematic drawing architecture of a deep reinforcement learning system 100 using asymmetric self-play for robust multi-robot flocking according to one embodiment of the present invention. The deep reinforcement learning system can serve as a platform for training robots tasked with navigating from a start area to a target area while maintaining a flocking motion pattern. The deep reinforcement learning system includes a plurality of tasked robots 110, a plurality of interferer robots 120, and static obstacles 130. A target area 140 is set in the deep reinforcement learning system, and the tasked robots 110 are set for navigating from a start area (where they are located originally) to the target area 140 while maintaining a flocking motion pattern. The arrangement of items in FIG. 9 is for illustrative purposes only, intended to show the types of objects that can be placed during training.

Each of the tasked robots 110 is equipped with physical communication devices, enabling real-time data transmission and information sharing to ensure coordination and cooperation with other tasked robots 110. In various embodiments, the tasked robots 110 are equipped with sensors, including LiDAR, cameras, and ultrasonic sensors, which allow them to obtain real-time information about their surrounding environment, facilitating obstacle detection and position recognition, thereby enhancing their autonomous navigation and decision-making capabilities. Furthermore, all of the tasked robots 110 are equipped with modules or models for learning to adapt to ever-changing conditions. These modules and models are described further below.

The interferer robots 120 are configured to dynamically disrupt the movement of the tasked robots 110, creating challenges in their environment. The static obstacles 130 also serve as challenges to the movement of the interferer robots 120. The tasked robots 110 are trained to adapt and find better ways to navigate. This interaction helps the tasked robots 110 improve their navigation and decision-making skills, allowing them to complete their tasks even when faced with disruptions. By learning to avoid the interferer robots 120 and the static obstacles 130, the tasked robots 110 become more effective and resilient in real-world situations.

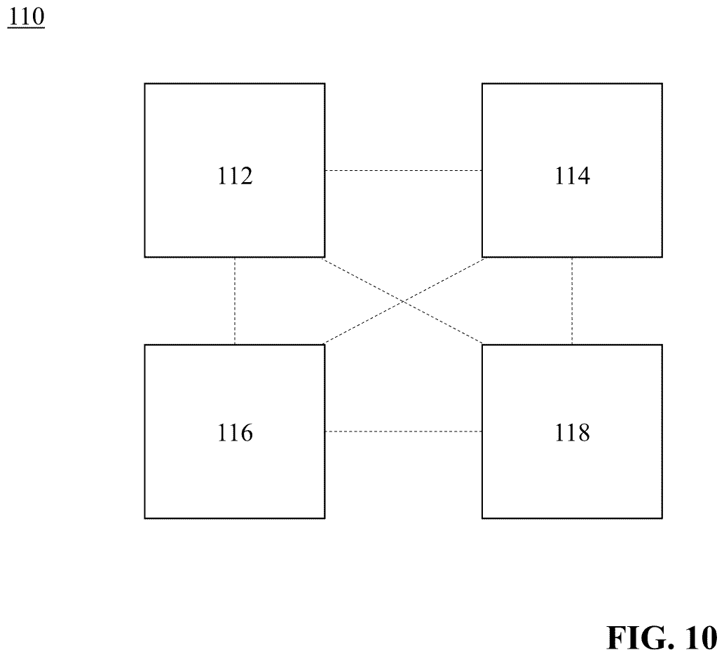

The network architecture of ASFC, as discussed in FIG. 2, can be applied to the modules and models equipped in the tasked robots 110, enabling them to function during the training stage. Specifically, FIG. 10 depicts a schematic drawing of an architecture of a tasked robot 110 according to one embodiment of the present invention. Each of the tasked robots 110 includes a reinforcement learning control module 112, an auxiliary training module 114, a reward function module 116, and a two-stage self-adversarial training module 118. These modules are in communication with each other, enabling the transfer, reception, and exchange of information. Additionally, the modules are connected to the tasked robots' 110 sensors, allowing them to receive environmental data in real-time and adjust the robots' navigation strategies accordingly.

The reinforcement learning control module 112 is configured to dynamically adjust the robot's behavior to help it make optimal decisions. The reinforcement learning control module 112 can continuously learn and improve through real-time feedback mechanisms and include a target navigation model, a cluster behavior maintenance model, and a collision avoidance model.

The target navigation model is responsible for guiding the tasked robot 110 toward a predetermined target area, such as the target area 140. By the target navigation model, the tasked robot 110 continuously calculates its distance from the target and generates action commands based on this information, guiding the tasked robot 110 to reduce the distance to the target, ensuring it always moves towards the target during task execution.

The cluster behavior maintenance model is responsible for maintaining cluster behavior. To ensure that multiple tasked robots 110 can coordinate their movements, the cluster behavior maintenance model monitors the relative positions and distances between/among the tasked robots 110. For the tasked robots 110, the cluster behavior maintenance model adjusts their movements to maintain coordination within the group.

The collision avoidance model is responsible for collision avoidance. By sensing the surrounding environment, the tasked robot 110 identifies potential obstacles and interferences via the collision avoidance model, generating avoidance strategies. The collision avoidance model adjusts the trajectory for the tasked robot 110 in response to the relative position of obstacles (e.g., interferer robots 120 and static obstacles 130), avoiding collisions and ensuring safety.

Moreover, the reinforcement learning control module 112 uses the Proximal Policy Optimization (PPO) algorithm to optimize action and value learning in the neural network, incorporating both convolutional neural network (CNN) and multi-layer perceptron (MLP) architectures. The reinforcement learning control module 112 employs a framework that uses feature-level attention mechanisms for action learning and agent-level attention mechanisms for value learning. Action learning allows each tasked robot 110 to make independent decisions through repeated training, where they accumulate experience and refine strategies in a decentralized execution mode, reducing reliance on central control. Meanwhile, value learning occurs during centralized training, where all tasked robots 110 share environmental data and strategy feedback to optimize decision-making. This collective information sharing helps the tasked robots 110 better understand their surroundings and improves coordination. By integrating these learning approaches, the reinforcement learning control module 112 enhances collaboration and autonomous decision-making in complex environments.

The auxiliary training module 114 is configured to enhance environmental perception for the tasked robot 110, enabling them to better predict dynamic changes around the tasked robot 110. The auxiliary training module 114 includes a local environment grid estimation model, a motion prediction model, and a decision optimization model.

The local environment grid estimation model generates a small-scale environmental grid map at each time step, displaying the status of obstacles, interferences, and other tasked robots 110 around the self-robot. This map provides crucial contextual information for making subsequent decisions.

The motion prediction model analyzes and predicts the trajectories of other tasked robots 110, as well as the behavior of obstacles and interferences, based on the generated environmental grid map. This prediction enables the tasked robots 110 to formulate strategies in advance, minimizing unexpected incidents and ensuring smooth task execution.

The decision optimization model provides environmental information and relays this data to the reinforcement learning control module 112, assisting in decision optimization. By anticipating environmental changes, the tasked robots 110 can better adapt to different situations, improving overall task efficiency.

The reward function module 116 is designed to reward the tasked robots 110 for performing beneficial actions during training and establishes multiple reward mechanisms to encourage the tasked robots 110 to achieve specific objectives. In one embodiment, the reward function module 116 comprises a reward model.

The reward model provides feedback in the form of target proximity rewards, formation maintenance rewards, and obstacle avoidance rewards to the tasked robots 110 when they meet specific conditions. For example, when a tasked robot 110 approaches the target area 140, the reward function module 116 grants positive rewards based on the reward model, motivating the robot to continue moving forward. Similarly, when the tasked robot 110 maintains an appropriate position within the cluster, it receives rewards from the reward model, encouraging collaboration. Additionally, when the tasked robot 110 successfully avoids collisions with interferer robots 120 and static obstacles 130, it is rewarded, promoting safe navigation.

Furthermore, in one embodiment, each of the interferer robots 120 is equipped with an interferer reward model, which provide a mechanism encouraging the interferer robots to approach the flocking robots (e.g., the tasked robot 110). When an interferer robot 120 successfully collides with a flocking robot (e.g., the tasked robot 110), it receives a reward. The reward is designed to incentivize interferer robots 120 to engage with the tasked robots 110, promoting challenging scenarios for training.

The two-stage self-adversarial training module 118 is designed to enhance the adaptability of the tasked robots 110 in complex environments through adversarial training, consisting of two stages.

The first stage is skill enhancement training. In this stage, the tasked robots 110 and the interferer robots 120 train simultaneously, interacting through the two-stage self-adversarial training module 118. This interaction helps the tasked robots 110 improve their ability to handle unexpected situations and complete tasks despite interference. The network parameters of the interferer robots 120 are periodically stored in a model pool, enabling the tasked robots 110 to train against different levels of adversarial intelligence.

The second stage is strategy testing and optimization. In this stage, the two-stage self-adversarial training module 118 introduces increasingly complex adversarial models to test and optimize the strategies of the tasked robots 110. By simulating more intelligent interferences or challenging environments, the tasked robots 110 are forced to continuously adapt and refine their strategies for improved generalization. To enhance environmental diversity, interferer models are sampled in different combinations from the model pool, and curriculum learning is applied. This process gradually increases the complexity of scenarios, focusing on stronger interferers to challenge the robots.

In some embodiments, the auxiliary training module 114 assists both the reinforcement learning control module 112 and the two-stage self-adversarial training module 118 by providing additional focused training or skill enhancements to refine the robot's capabilities. The reward function module 116 helps shape the decisions of the reinforcement learning control module 112 by reinforcing beneficial behaviors learned during interactions with the two-stage self-adversarial training module 118. The two-stage self-adversarial training module 118 introduces dynamic and increasingly challenging adversarial conditions to push the reinforcement learning control module 112 to adapt and improve, according to input from both the reward function module 116 and the auxiliary training module 114.

While the aforementioned content describes implementing the modules/models on the tasked robot itself, in other embodiments, these modules/models can be hosted on a central server that stores the functionalities. The tasked robot can then receive training or execute tasks via communication with the central server, allowing the modules/models to be remotely operated and controlled without being directly installed on the tasked robot. This configuration enables more efficient processing and centralized management of training or task execution. Similarly, the central server can store functionalities and communicate with interferer robots to control their actions or behaviors. This setup allows the interferer robots to receive instructions or adjustments remotely during training or task execution, improving efficiency in managing and coordinating the interferer robots without requiring the modules/models to be installed directly on each unit.

The present disclosure focuses on flocking control in highly dynamic and communication-denied environments by proposing ASFC. The disclosed two-stage self-play training approach enables continuous enhancement of the flocking policy through the interaction with learnable and adversarial interferers. Additionally, the auxiliary training module mitigates the impact of environmental uncertainties, ensuring more robust control. The effectiveness and practicality of the ASFC framework have been validated through extensive simulations and real-world experiments. This framework offers significant advancements in flocking control, with potential applications in complex and challenging environments.

In the present disclosure, the two-stage self-adversarial training approach enhances the adaptability of robots in complex environments by employing a structured training workflow. This training approach allows the robots to refine their responses to adversarial conditions and optimize their strategies without being overwhelmed by the complexity of the tasks. Furthermore, this method improves the overall robustness of the training process, enabling the robots to efficiently manage resources and adapt to dynamic environments, ultimately maximizing their performance and operational effectiveness.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A tasked robot for a deep reinforcement learning system using asymmetric self-play for robust multi-robot flocking, comprising:
a reinforcement learning control module configured to dynamically adjust robot's behavior to help it make optimal decision and to continuously learn and improve through real-time feedback mechanisms, wherein the reinforcement learning control module comprises:
a target navigation model for guiding the tasked robot toward a predetermined target area, continuously calculating a distance from the tasked robot to the target area, and generating action commands based on calculated information, guiding the tasked robot to reduce the distance to the target area;
a cluster behavior maintenance model for maintaining cluster behavior and monitoring relative positions and distances between or among other robots with respect to the tasked robot, such that the cluster behavior maintenance model adjusts movement of the tasked robot to maintain coordination within a robot group; and
a collision avoidance model for collision avoidance, wherein the collision avoidance model adjusts a trajectory for the tasked robot in response to a relative position of obstacles and interferer robots; and
an auxiliary training module configured to enhance environmental perception for the tasked robot, enabling the tasked robot to predict dynamic changes around the tasked robot, wherein the auxiliary training module comprises:
a local environment grid estimation model configured to generate a small-scale environmental grid map at each time step, so as to display a status of obstacles, interferences, and other robots around the tasked robot, which provides contextual information for making subsequent decisions for the tasked robot; and
a motion prediction model configured to analyze and predict trajectories of other robots and properties of obstacles and interferences, based on the generated environmental grid map.

2. The tasked robot according to claim 1, wherein the reinforcement learning control module is further configured to optimize action learning and value learning in a neural network thereof using a Proximal Policy Optimization (PPO) algorithm, incorporating both convolutional neural network (CNN) and multi-layer perceptron (MLP) architectures.

3. The tasked robot according to claim 2, wherein the reinforcement learning control module employs a framework that uses feature-level attention mechanisms for the action learning and agent-level attention mechanisms for the value learning, and wherein the action learning allows the tasked robot to make independent decisions through repeated training in a decentralized execution mode, and the value learning occurs during centralized training, where the tasked robot and other robots share environmental data, providing collective information sharing.

4. The tasked robot according to claim 1, further comprising a reward function module configured to reward the tasked robot for performing beneficial actions during training and comprising:
a reward model configured to provide feedback in a form of target proximity rewards, formation maintenance rewards, and obstacle avoidance rewards to the tasked robot when the tasked,
wherein, when the tasked robot approaches the target area, the reward function module grants positive rewards based on the reward model, motivating the robot to continue moving forward,
wherein, when the tasked robot maintains an appropriate position within a cluster of robots, the tasked robot receives rewards from the reward model, encouraging collaboration,
wherein, when the tasked robot successfully avoids collisions with interferer robots and static obstacles, the tasked robot is rewarded, promoting safe navigation.

5. The tasked robot according to claim 1, further comprising:
a two-stage self-adversarial training module configured to enhance adaptability of the tasked robot in complex environments through adversarial training, consisting of a first stage and a second stage,
wherein, in the first stage, the tasked robot and interferer robots are trained simultaneously, interacting through the two-stage self-adversarial training module, and wherein network parameters of the interferer robots are periodically stored in a model pool, enabling the tasked robot to train against different levels of adversarial intelligence,
wherein, in the second stage for the strategy testing and optimization, the two-stage self-adversarial training module introduces complex adversarial models to test and optimize the strategies of the tasked robot, and wherein interferer models are sampled in different combinations from the model pool.

6. A deep reinforcement learning system using asymmetric self-play for robust multi-robot flocking, comprising:
a plurality of interferer robots;
a plurality of static obstacles;
a start area and a target area; and
a plurality of tasked robots activated to move from the start area to the target area, navigating past the interferer robots and the static obstacles, wherein each of the tasked robots is equipped with physical communication devices, enabling real-time data transmission and information sharing for coordination and cooperation with other tasked robots;
wherein each of the tasked robots comprises:
a reinforcement learning control module configured to dynamically adjust robot's behavior to help it make optimal decision and to continuously learn and improve through real-time feedback mechanisms, wherein the reinforcement learning control module comprises:
a target navigation model for guiding the tasked robot toward the target area, continuously calculating a distance from the tasked robot to the target area, and generating action commands based on calculated information, guiding the tasked robot to reduce the distance to the target area;
a cluster behavior maintenance model for maintaining cluster behavior and monitoring relative positions and distances between or among other robots with respect to the tasked robot, such that the cluster behavior maintenance model adjusts movement of the tasked robot to maintain coordination within a robot group; and
a collision avoidance model for collision avoidance, wherein the collision avoidance model adjusts a trajectory for the tasked robot in response to a relative position of the interferer robots and the static obstacles; and
an auxiliary training module configured to enhance environmental perception for the tasked robot, enabling the tasked robot to predict dynamic changes around the tasked robot, wherein the auxiliary training module comprises:
a local environment grid estimation model configured to generate a small-scale environmental grid map at each time step, so as to display a status of the interferer robots, the static obstacles, and other robots around the tasked robot, which provides contextual information for making subsequent decisions for the tasked robot; and
a motion prediction model configured to analyze and predict trajectories of other robots and properties of the interferer robots and the static obstacles, based on the generated environmental grid map.

7. The deep reinforcement learning system according to claim 6, wherein the reinforcement learning control module is further configured to optimize action learning and value learning in a neural network thereof using a Proximal Policy Optimization (PPO) algorithm, incorporating both convolutional neural network (CNN) and multi-layer perceptron (MLP) architectures.

8. The deep reinforcement learning system according to claim 7, wherein the reinforcement learning control module employs a framework that uses feature-level attention mechanisms for the action learning and agent-level attention mechanisms for the value learning, and wherein the action learning allows the tasked robot to make independent decisions through repeated training in a decentralized execution mode, and the value learning occurs during centralized training, where all the tasked robots share environmental data, providing collective information sharing.

9. The deep reinforcement learning system according to claim 6, wherein each of the tasked robots further comprises a reward function module configured to reward the tasked robot for performing beneficial actions during training and comprising:
a reward model configured to provide feedback in a form of target proximity rewards, formation maintenance rewards, and obstacle avoidance rewards to the tasked robot when the tasked,
wherein, when the tasked robot approaches the target area, the reward function module grants positive rewards based on the reward model, motivating the robot to continue moving forward,
wherein, when the tasked robot maintains an appropriate position within a cluster of the tasked robots, the tasked robot receives rewards from the reward model, encouraging collaboration,
wherein, when the tasked robot successfully avoids collisions with the interferer robots and the static obstacles, the tasked robot is rewarded, promoting safe navigation.

10. The deep reinforcement learning system according to claim 6, wherein each of the tasked robots further comprises a two-stage self-adversarial training module configured to enhance adaptability of the tasked robot in complex environments through adversarial training, consisting of a first stage and a second stage,
wherein, in the first stage, the tasked robots and the interferer robots are trained simultaneously, interacting through the two-stage self-adversarial training module, and wherein network parameters of the interferer robots are periodically stored in a model pool, enabling the tasked robot to train against different levels of adversarial intelligence,
wherein, in the second stage for the strategy testing and optimization, the two-stage self-adversarial training module introduces complex adversarial models to test and optimize the strategies of the tasked robots, and wherein interferer models are sampled in different combinations from the model pool.

11. The deep reinforcement learning system according to claim 6, wherein each of the interferer robots is equipped with an interferer reward model, which provide a mechanism encouraging the interferer robots to approach the tasked robot, and wherein, when anyone of the interferer robots successfully collides with one of the tasked robots, it receives a reward from the interferer reward model.

12. The deep reinforcement learning system according to claim 6, wherein each of the tasked robots and the interferer robots is configured to execute steering commands comprising linear and angular velocities, and an action space for each of the tasked robots is with four linear velocity options: 0 m/s, 0.15 m/s, 0.3 m/s, and 0.5 m/s, and with nine angular velocity options: −2 rad/s, −1.2 rad/s, −0.8 rad/s, −0.3 rad/s, 0 rad/s, 0.3 rad/s, 0.8 rad/s, 1.2 rad/s, and 2 rad/s, and wherein, for each of the interferer robots, an angular velocity options remains the same as that of the tasked robots, while a linear velocity options are 0 m/s, 0.15 m/s, 0.3 m/s, and 0.38 m/s.

13. The deep reinforcement learning system according to claim 6, wherein the deep reinforcement learning system serves as a platform for training the robots tasked with navigating from the start area to the target area while maintaining a flocking motion pattern via a two-stage flocking training, and a scenario of a first stage is 15 m×15 m in size with the five flocking tasked robots, the three interferer robots, and the two static obstacles, and wherein the scenario of a second stage is 25 m×25 m in size with the eight flocking tasked robots, the six interferer robots, and the five static obstacles.
